(19) United States
(12) Patent Application Publication
(10) Pub. No.: US 2008/0039121 A1
(43) Pub. Date: Feb. 14, 2008

(54) Methods and Systems for Establishing Relationships Between Mobile Communication Device Users

(76) Inventors: Thomas Muller, Berlin (DE); Jan Schulz, Berlin (DE); Lars Henrik Grau, Berlin (DE); Marhus Juhr-De Benedetti, Gauting (DE)

Correspondence Address: MICHAEL TOBACK, 12200 SARAGLEN DRIVE, SARATOGA, CA, 95070, US

(21) Appl. No.: 11/831,959

(22) Filed: Aug. 1, 2007

(30) Foreign Application Priority Data
Aug. 9, 2006 (DE) 10 2006 037 250.6

(51) Int. Cl. H04M 3/42; G06F 7/00

(52) U.S. Cl. 455/456.3; 707/6

(57) ABSTRACT

A method of establishing a community including a first mobile communication device user and a second mobile communication device user is disclosed. The method includes receiving a first message from the first mobile communication device user and receiving a second message from the second mobile communication device user. The method further includes parsing the first message and the second message to determine a first user identifier and a first user-generated key and a second user identifier and a second user-generated key respectively. Furthermore, the method includes calculating a matching probability between the first mobile communication device user and the second mobile communication device user based on at least one of a proximity of distance, a proximity of time of the receipt of messages, and matching of the user-generated keys.

### CROSS-REFERENCE TO RELATED APPLICATIONS

This application is a Continuation In Part application of German patent application no. 10 2006 037 250.6, entitled “Verfahren und Vorrichtungen zur Identifikationsverifikation” (methods and systems for identity verification) filed on Aug. 09, 2006, by inventors Thomas Müller, Jan Schulz, and Lars Henrik Grau, which is incorporated herein by reference in its entirety for all purposes.

### FIELD OF THE INVENTION

The invention generally relates to identifying and establishing communities among mobile communication device users.

### BACKGROUND AND DESCRIPTION OF THE RELATED ART

In their daily lives, people are constantly seeking to enter into relationships and communicate with other humans. Modern technological modes of communication are very convenient, very easy to use, and very efficient.

Currently a number of ways to approach and establish relationships with other individuals exists. For example, in the case where few individuals are in the same physical location, a traditional method is to go up to the other person, instantly start communication, and explicitly consent to (or reject) a relationship and subsequent communication in a particular context. Consent could be established by exchanging business cards or phone numbers. The context is generally tied to the purpose, the time, or the location of the encounter. On the one hand, this traditional personal introduction has advantages: it is instantaneous and genuine (“what you see is what you get”). People have the flexibility to only share personal information as they see fit in that context. On the other hand, this method has drawbacks: it requires substantial effort to obtain and keep up-to-date the contact information of each individual and more importantly remember and distinguish between the contexts of the increasingly many relationships in which people engage today.

Methods for identifying and establishing relationships with previously unknown individuals also exist in cases where the individuals are not in the same physical location. Examples of these methods have historically included anonymous classified and personals advertisements, and dating or matchmaking services. In addition, with the advent of the Internet, two extremely efficient methods have emerged as ways of establishing and identifying relationships and communicating with previously unknown parties; these two methods are known as on-line dating and social networking.

Networking and on-line and mobile dating services require individuals to register in advance and complete user profiles typically including an anonymous or public summary of an individual's background, skills, experience, likes, dislikes and other personal information including a picture of the individual kept in a central database. Users of these services can then employ various search criteria such as gender, geographic location of one's residence or specific activities in which they are interested in order to identify a subset of other users in whom they may be interested. The user conducting the search can then browse through this subset of other users to view their pictures and individual profiles in order to decide whether or not to contact them. If they choose to contact another user, a message is sent by the service to that specific person.

It is within this context that embodiments of the invention arise.

### SUMMARY OF INVENTION

Broadly speaking, the present invention enables users to build communities based on readily and ubiquitously available mobile phone technology and on contextual dimensions in particular including time, a user's current geographic location, and a user-defined key. This is achieved by providing: the creation of a token which identifies a potential community based on some combination of one or more properties of times user-defined key, and geographic location; the use of the resulting token to indicate to other members of the community your interest in establishing such a relationship; and providing a basis for identifying the source of the message using the same token.

Establishing communities generally involves the communication of people before, during or after an encounter. In many-to-many situations, people want to establish relationships with each other to form communities. In one-to-one situations, this communication may go hand in hand with the fear of rejection.

As examples, consider the following situations: (a) a group of college students meet in a bar, and decide ad-hoc to go out again. Imagine this instant community of drinking buddies can be established on-the-fly at the push of a button and subsequently any member can communicate with all others, if the time/date or venue of the next appointment needs to be agreed or changed, or if they can not attend; (b) At the concert of a popular music band Robby, the event organizer invites the fans to join the Robby community to subsequently meet other Robby fans. Imagine this instant community of potentially 1,000s of members can be established by each pushing a button on their mobile phone after taking an impromptu picture of themselves, if desired. Subsequently, community members can look up and contact other attendees; (c) A man and a woman have an encounter, both feel a certain “romantic spark”, but both go their separate ways regretting the missed opportunity to ask the other for a “date”. Imagine a “second chance” can be established afterwards at the push of a button on the mobile phone. If and only if both feel the same, they would each reveal their interest in each other along with the most minimal personal information (e.g. an impromptu picture of themselves) they deem appropriate.

It should be appreciated that the embodiments of the present invention can be implemented in numerous ways in software, hardware, or a combination thereof. Various embodiments can be distinguished depending on usage of one or more of time, user-defined key, and location attributes for identifying and establishing communities among persons. Two exemplary embodiments that use the following combination of attributes (e.g. time, user-defined key, location) are described in detail:

### (1) Pre-agreed (“ex-ante”) Community based on user-defined key and time;

### (2) Retrospective (“ex-post”) Community based on location and time.

In one embodiment, the user-defined key is made of a combination of letters, special characters, numerals, or words. In another embodiment, the user-defined key is made of a combination of letters and numerals. In yet another embodiment, a user-defined key is made of numbers only. In one embodiment, a location is a street address. In another embodiment, the location is at least one of the name of a street, the name of a town, the name of a landmark, longitude and latitude identification. In another embodiment, the location could be any identification so long as a physical location may be ascertained unambiguously from that identification.

In one embodiment, a computer-implemented method of establishing and identifying relationships between mobile communication device users is provided. Messages received from users are parsed to obtain user identifiers and keywords as user-defined keys. The probability that a match was intended, or an encounter between users did take place (hereinafter referred to as the “matching probability”) between users is then calculated using the time of transmission of each message (hereinafter referred to as the “receive time” of the message, or simply the “time” of the message), the location from which the message was sent, and the probability of whether the user-defined keys match. In one embodiment, the process of matching of the user-defined keys takes into account common misspellings and typographical errors.

In another embodiment, an apparatus for establishing and identifying relationships between mobile communications device users is provided. The apparatus includes an inbound message receiver, outbound message sender, and a scoring engine. The inbound message receiver will receive a request message sent from a mobile communication device. The outbound message sender will convert a response message according to a mobile communication protocol and send the response message to the mobile communication device. The scoring engine will calculate a matching probability of a match between at least two mobile communication device users, wherein the matching probability is calculated using at least one of the identifiers: a distance between the mobile communication devices users, a difference in time of receipt of messages from the mobile communication device users, and a match of keys defined by the mobile communication device users.

In yet another embodiment, a computer readable media having program instructions for executing a computer-implemented method identifying and establishing relationships between mobile communication device users is provided. Messages received from users are parsed to obtain user identifiers and user-defined keys. The matching probability is then calculated using the time of receipt of each message, location from which the message was sent, and whether the user-defined keys match.

### BRIEF DESCRIPTION OF THE DRAWINGS

The present invention will be readily understood by the following detailed description in conjunction with the accompanying drawings. To facilitate this description, like reference numerals designate like structural elements.

FIG. 1A illustrates a prior art scenario for establishing a relationship between people.

FIG. 1B illustrates how retrospective community building resolves a variant of the prisoner's dilemma between two individuals who may be romantically interested in each other in a two-step approach, in accordance with one embodiment of the present invention.

FIGS. 1C, 1D, and 1E illustrate various scenarios in the identification, verification, and community or social relationship building process between mobile communication device users based on received messages and identification characteristics, in accordance with one embodiment of the present invention.

FIGS. 2A-2C illustrate the temporal aspects of matching in a scenario based on a community, in accordance with one embodiment of the present invention.

FIG. 3 illustrates a system and network for sending, receiving, generating and processing messages, in accordance with one embodiment of the present invention.

FIG. 4 illustrates an embodiment of the data structure of a user and the membership of a mobile device user in a user list, in accordance with one embodiment of the present invention.

FIG. 5 illustrates a control flow of creating user lists, in accordance with one embodiment of the present invention.

FIG. 6 illustrates the login request flow within the network, in accordance with one embodiment of the present invention.

FIG. 7 illustrates the establishment of relationships between users based on time and proximity factors as well as the method of scoring, in accordance with one embodiment of the present invention.

FIG. 8 illustrates a scoring equation for computing temporal and geographical distances and the matching probability, in accordance with one embodiment of the present invention.

FIG. 9A illustrates an exemplary login page, in accordance with one embodiment of the present invention.

FIG. 9B illustrates an exemplary specify location page, in accordance with one embodiment of the present invention.

FIG. 10A illustrates an exemplary dashboard page, in accordance with one embodiment of the present invention.

FIG. 10B illustrates an exemplary chat page, in accordance with one embodiment of the present invention.

The figures are provided in order to provide a thorough understanding of the present invention. The figures should not be construed as limiting the breath of the invention in any manner.

### DETAILED DESCRIPTION

Methods and apparatus for identifying and establishing communities among mobile communication device users are disclosed. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

As used herein, the term “community” refers to the creation of a set of relationships between two or more individuals based on some common event, such as meeting at a concert, expressing an interest in friendship at a point in time, etc. In one embodiment, term “community” also refers to creation of a network, a community, or a relationship spontaneously based on a shared encounter. A community is a social, religious, occupational, or other group sharing common characteristics or interests and perceived or perceiving itself as distinct in some respect from the larger society within which it exists.

Community building involves many-to-many interactions, essentially creating n*(n−1)/2 bilateral relationships between n members. Embodiments of the present invention disclose a hub-and-spoke networking approach, where multiple individuals communicate through a central network.

People encounter each other in the real physical world sharing “something in common” (e.g., a common interest, objective, hobby, or a mutual attraction to each other) and desire to establish relationships with each other. Hence, those individuals will have to indicate and confirm to the other their respective interest in each other. If the individuals involved in the encounter choose not to immediately do so because they are too shy to address the other, one embodiment provides them with a “second chance” to subsequently meet by displaying identification characteristics: the approximate time of the first encounter and the approximate location of the encounter to other mobile communication device users who were previously temporally and geographically close.

The challenges with networking services are that they do not provide an efficient way to consistently maintain the oftentimes short-lived, dynamic contexts of the “communities” between individuals. Furthermore, they require an exponential effort to establish relationships between people who want to all establish a community.

Networking services and on-line or mobile or proximity-based services have one main drawback: relationships cannot be truly established spontaneously, because the services always require premeditation and preparation (e.g., individual pre-registration by each member and the set-up of a dedicated web-site, or programming a portable device). Challenges with current mobile and on-line dating systems are that they do not support positive partner selection in the real physical world, and they do not eliminate fear of rejection. Embodiments of the present invention enable individuals to efficiently identify and initiate communication with an unknown person they met in the past if and only if both desire to do so.

One of the advantages of embodiments of the present invention is that users maintain control because a communication is not allowed to be initiated without mutual consent. Moreover, privacy and anonymity are maintained because personal information is not required for establishing a match.

Embodiments of the present system provide methods for the efficient, simultaneous, and instant establishment of communities with large numbers of other mobile communication device users. Embodiments of the present system reflect the highly dynamic character of today's social relationships between humans or enables users to build “communities” keeping the communication between its members highly convenient, meaningful, and at the same time keeping contact and other personal information private. Similarly, embodiments of the present system enable a user to anonymously indicate interest in (e.g. an intimate encounter or relationship with) another user after an initial encounter in the real physical world.

A system, apparatus, and method are presented in which a server that is connected to a worldwide communications network receives messages from users' of mobile communication devices, which represent at least one of the identification characteristics. Then the system selects the users whose identification characteristics lie within a defined range for the identification characteristics.

The system receives messages with the identification characteristics time, location, and user-defined key, provides a web user interface that groups and displays mobile communication device users whose messages fulfill certain criteria with respect to each other, and enables those users to communicate and to establish a community.

The users of mobile devices are able to create an instant community of users. The system receives messages with the above mentioned identification characteristics and efficiently establishes bilateral relationships between those mobile communication device users whose messages with matching user-defined keys were received within a pre-defined time-span, and/or within a pre-defined geographical limitation.

Among many, one advantage of the embodiments of the present invention is that the community building process is efficient because each person has to only execute one action (i.e. less information is exchanged); hence, in total, all persons have to only perform linear efforts.

With this overview in mind, the following figures will illustrate examples, structure, method and apparatus for establishing and identifying communities among mobile communication device users.

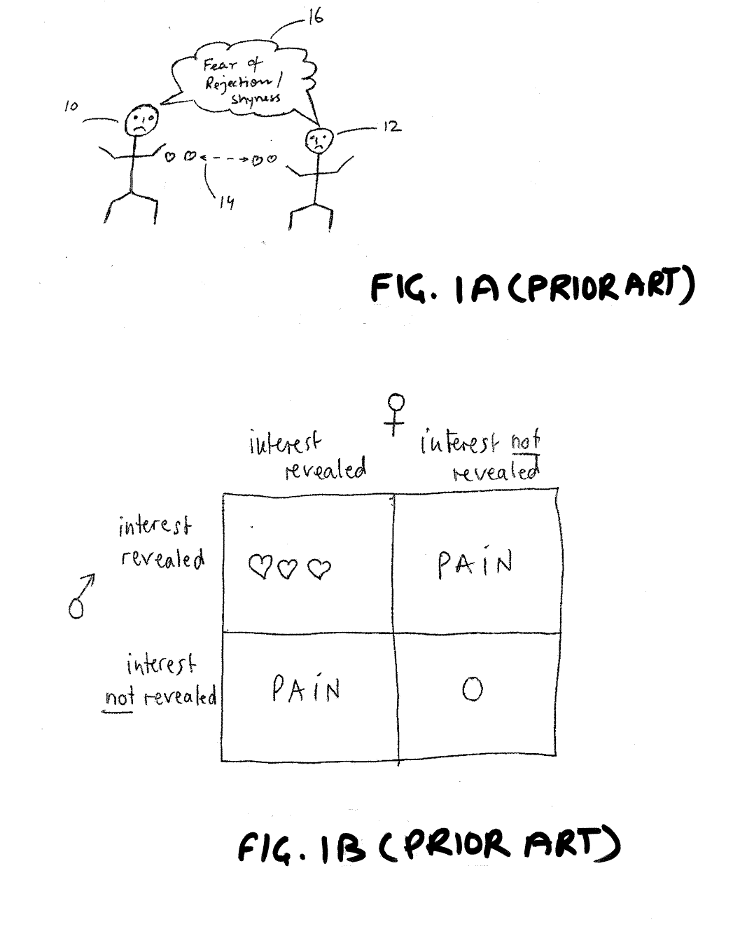

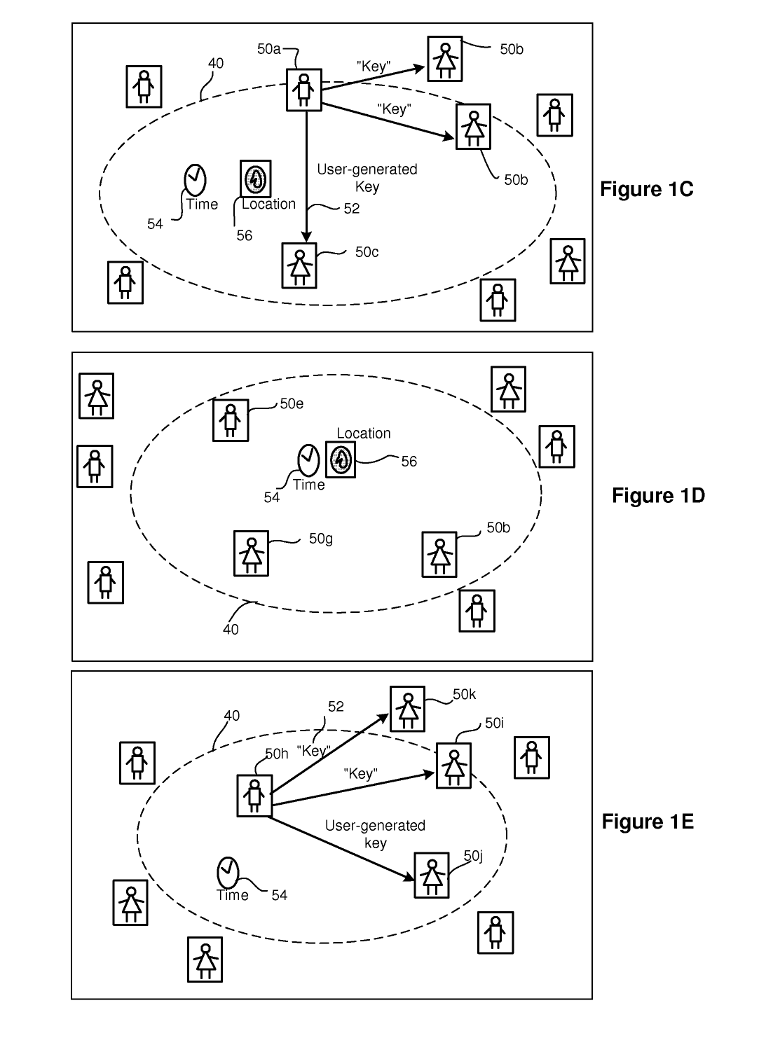

FIG. 1A illustrates a prior art scenario for establishing a relationship or community. One person 10 perceives a possible connection 14 with another 12, but must overcome the fear of rejection 16 and hence may not reveal the perceived connection 14. Further, the other person 12 may have this same fear 16, and may equally not reveal the perceived connection.

This situation can be described as a variation of the classical prisoner's dilemma: Assume person 10 and person 12 both “feel attracted” to each other, but both fear rejection. Like in the classical form, both have the option to reveal their interest (“cooperate”) or not to do so (“reject”). If both reveal their interest, they will both gain (win/win). However, if one person reveals their interest and the other does not (i.e. “rejects”), then the cooperator's perceived “pain caused by the rejection” is potentially significant. Unlike in the classical form, in order to optimize their own outcome it is in this variation not always better to “reject” but to make one's choice dependent on the other person's behavior. It is important for each person to only reveal their interest (“cooperate”), if (and only if) the other person does so as well.

FIG. 1B illustrates a decision matrix between the two individuals. Experience in daily life shows that fear of rejection is oftentimes larger than the desire for romance, leading to many “missed opportunities”. Note, however, that rejection is only possible, if one's interest in indeed revealed. Retrospective community building resolves this variant of the prisoner's dilemma between the two individuals in a two-step approach: First, both independently make their choice; second, interest is only revealed if mutual, and not revealed, if interest was one-sided. Neither case leads to rejection.

### Building Communities

FIG. 1C illustrates an embodiment of forming a community 40. In one embodiment, a mobile communication device user 50a wishes to establish a community 40 with one or more other mobile communication device users based on time 54, location 56, and a user-defined key 52. User 50a defines and communicates (e.g., by word-of-mouth) a user-defined key 52 to other mobile communication device users 50b, 50c, and 50d. Only the mobile communication device users 50a, 50b, and 50c in possession of the key, who meet all three criteria, i.e. they sent the key 52 at the location 56 at the given time 54, will form community 40. The mobile communication device users (e.g., 50d), who have received the key 52 but do not meet the other criteria (e.g., they were not at the location 56 at a given time 54), will not be able to join the community 40. A community 40 may include any number of mobile communication device users as long as the “initiating” mobile communication device user 50a is able to effectively and efficiently communicate the key 52 to other mobile communication device users wishing to join the community 40.

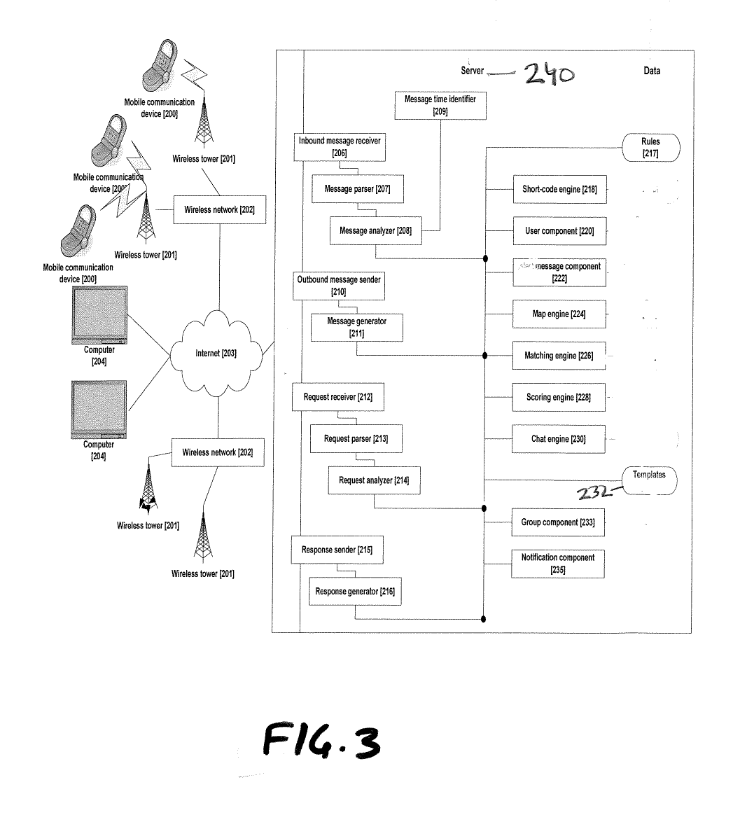

FIG. 1D illustrates another embodiment of community building. A mobile communication device user 50g wishes to establish a relationship with a mobile communication device user 50e based on both users' presence at or near a specific location 56 and an approximate time 54. In this embodiment, three mobile communication device users 50e, 50f, and 50g (potentially unknown to each other) each send a message to the server 240 (see FIG. 3) and thus form a community 40 solely based on identification characteristics time and location.

FIG. 1E illustrates yet another embodiment. An initiating mobile communication device user 50h defines and communicates a key 52 to mobile communication device users 50i, 50j, 50k. The key 52, in combination with the time 54 of transmission would enable mobile communication device users 50h, 50i, and 50j to form a community 40 as in the previously-described embodiment but solely based on the identification characteristics time and user-defined key enabling building of a community 40 irrespective of location. In this embodiment, the key would be either broadcasted, or advertised, or otherwise effectively, efficiently, and widely communicated to mobile communication device users.

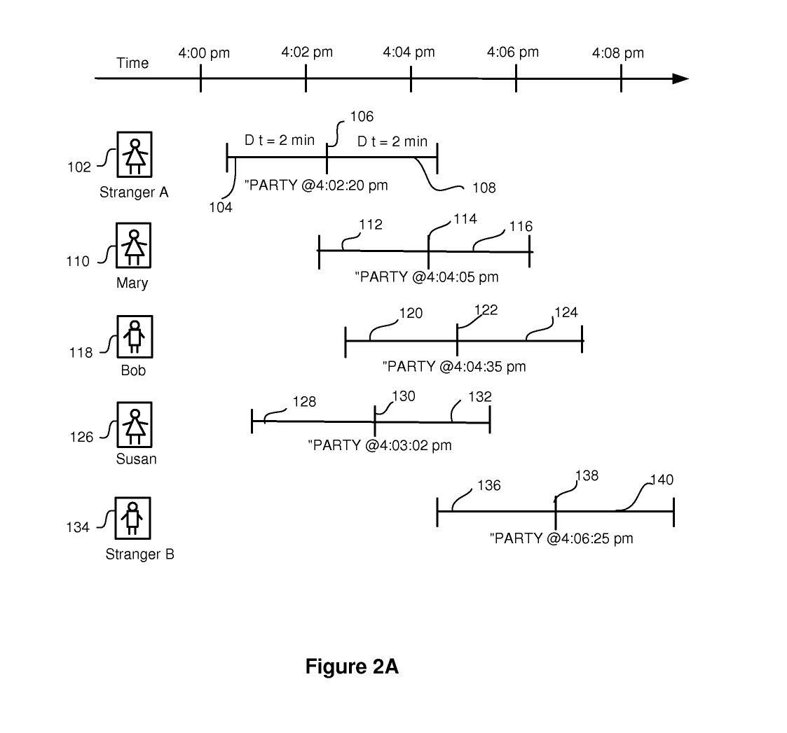

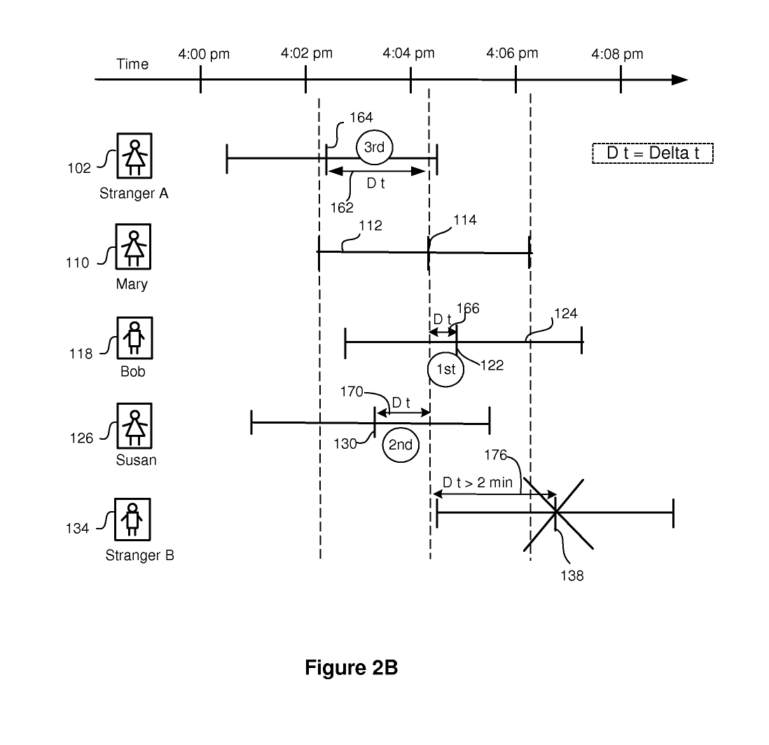

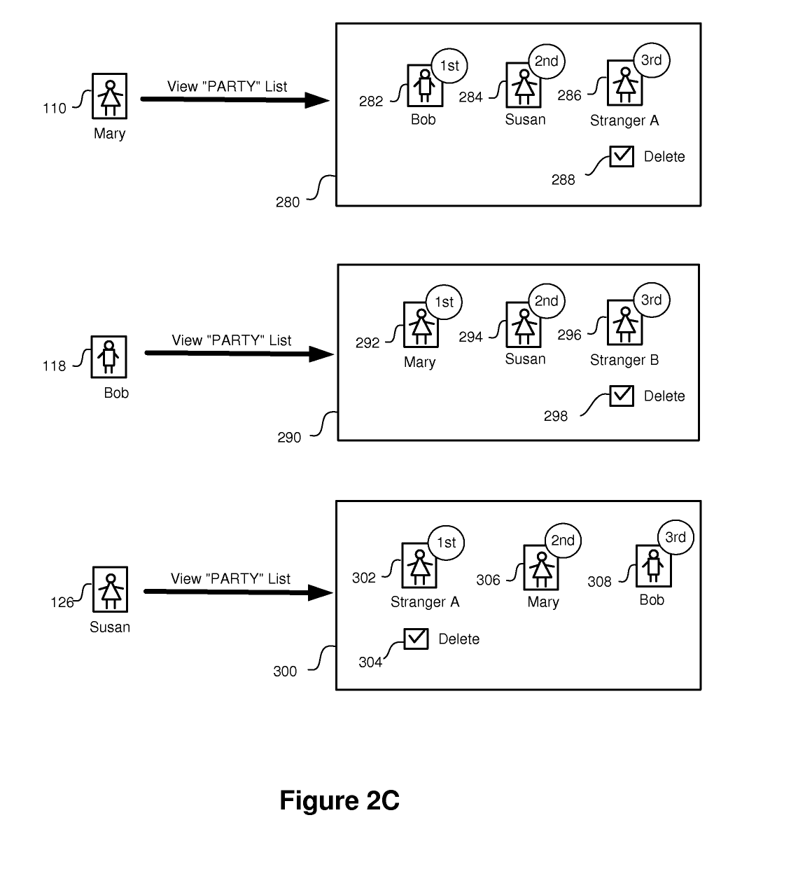

FIGS. 2A-2C illustrate examples of what three users would see in their “User Lists” based on a pre-defined stream of messages sent by the three users who are friends and two random other users. A “User List” as used herein refers to the list of members of a community that a user is a member of. The FIGS. 2A-2C focus on the temporal aspect of the matching (matching the times of the receipt of the messages) and on the sorting by “closeness” of the match; location and user-defined key (the key is “PARTY” in the example) are assumed to be the same.

By means of matching, each person only reveals themselves to those other persons who also revealed themselves by sending a message with the identification criteria of time and location. Note that a “match” between two persons is symmetric, i.e. if person A matches person B, than person B will also match person A. The match is, however, not transitive: if person B matches person C, than person A does not necessarily match person C.

FIG. 2A shows the temporal sequence of the messages with the key “PARTY” sent by:

| | |
|---|---|
| Stranger A 102 | at 4:02:20 pm |
| Susan 126 | at 4:03:02 pm |
| Mary 110 | at 4:04:05 pm |
| Bob 118 | at 4:04:35 pm |
| Stranger B 134 | at 4:06:25 pm |

Referring to FIG. 2A, five users send messages with the key “PARTY”. Stranger A 102, who is not known to Mary 110, Bob 118, or Susan 126, sends her message at a particular time 4:02:20 106. In this embodiment, the limits of temporal proximity are exemplarily defined as be 2 minutes before 104 the particular time 106 or after 108 the particular time 106 the message has been sent. Mary 110 sends her message at a time 4:04:05 114. Mary's 110 message is within 2 minutes of Stranger A's 102 message, as shown by the band before her message 112. Therefore, Mary 110 and Stranger A 102 would be potential matches. Bob 118 sent his message with the user-defined key “PARTY” at a time 4:04:35 122. The two-minute band prior to his message 120 gives him the possibility of matching Mary 110, but not Stranger A 102. Susan 126 sent her message at a time 4:03:02, such that the two-minute band prior to her message 128 will produce a potential match with Stranger A 102, while the two-minute band after she sent the message 132, will produce a potential match with Mary 110 and Bob 118. Finally, Stranger B 134 sends his message at a time 4:06:25 138, and his two-minute band prior to sending the message 136 will produce a potential match only with Bob 118. Note that if a potential match is produced in one direction it is also produced in the other direction.

FIG. 2B illustrates what Mary 110 will see in her User List; Bob 118 sent his message 122 “closest in time” 166 and would be “ranked first” (i.e. highest proximity score, the calculation of proximity score is described later in this document) based on the time he sent his message 122 relative to Mary 114; Susan would be second as her message 130 is further in time from Mary's 114 than Bob's 122. Stranger A 102 message was sent in time 106 third 164, but still within Mary's two-minute band 112. Mary 110 would not “see” the Stranger B 134 message 138 as his time falls outside of the exemplary 2-minute interval 176.

FIG. 2C shows the three User Lists in comparison—as they may appear on a screen. When Mary 110 selects her list around the user-defined key “PARTY”, she will see Bob 282, Susan 284, and Stranger A 286 on the screen 280. Mary 110 can then choose to delete any of them using the delete control 288. In this example, since Stranger A 286 is unknown to Mary 110, Mary 110 may remove the name of the Stranger A 286 from the screen 280. When Bob 116 selects his User List around the user-defined key “PARTY”, he will see a display 290 which shows Mary 292, Susan 294 and Stranger B 296. Bob can delete 298 any of them.

### Apparatus for Enabling Building Communities

FIG. 3 illustrates an exemplary apparatus for enabling community building, in accordance with one embodiment of the present invention. The apparatus includes mobile communication devices in communication with a communication network to establish relationships or communities. The mobile communication devices 200 send and receive messages. Wireless towers 201 that receive messages from mobile communication devices 200 and forward those messages to a wireless network 202. The wireless towers 201 also receive messages from a wireless network 202 and forward those messages to mobile communication devices 200.

Still referring to FIG. 3, the Internet 203 enables communication between the server 205 and wireless networks 202 such that the messages can be exchanged between the devices, including mobile communication devices 200 and user's computers 204. The wireless network 202 includes member's computers 204, and, mobile communication devices 200.

Still referring to FIG. 3, the server 240 contains an inbound message receiver 206 which receives messages from the Internet 203 and forwards those messages to a message parser 207. The message parser 207 breaks up each message into its message components. A message consists of a header and body. In one embodiment, the header consists of an MSISDN identifier. In one embodiment, the location indicator may be generated using a GPS system. In another embodiment users would enter location identifications by logging into the Internet interface of the system for identifying and establishing relationships and communities. In yet another embodiment, the communication network may provide an approximate location of the user at the time the user sent the message. The body consists of a text string representation of the user-defined key. The message time identifier 209 is generated from the receive time of the message.

Still referring to FIG. 3, the message components 222 are sent to a message analyzer 208 that analyzes a message to determine if the message comes from a user who is part of a community with which this user can be associated. The analysis occurs using specified parsing rules 217 which recognize and make available the header components and body of the message including the generated time identifier.

Still referring to FIG. 3, if the location is provided by the communication network or the GPS, the map engine 224 will verify that the user has opted in for automatic positioning (i.e. location attribute is to be included in the criteria for establishing the community). The user may also include the location attribute in the criteria by manually providing user's location at the time of sending the message.

In one embodiment, the user component 220 encapsulates the user profiles as well as their Mobile Station Integrated Services Digital Network identifier (MSISDN) 354. In one embodiment, the user profile includes login-code, password, sex, photo, age-group, email address, blacklist (a list of blocked users). In another embodiment, the user profile may include any service provider defined metadata of user profile so long as the user component 220 can encapsulate it.

The message component 222 creates and updates the users' messages as well as their time 54, location 56 and message specific filter criteria such as gender, age, and sexual orientation of the other encountered users. The map engine 224 manages maps, location coordinates such that if the message included location information and the association of messages with the location attribute.

The matching engine 226 processes data from the user component 220 against data from messages stored in the message component 222 using matching rules to select messages of relevant mobile communication device users. Matching rules compare the attributes of the message to specified criteria for a given community. For instance the message time must be within specific limits of other messages, and the users' keys or locations must match.

The scoring engine 228 computes for each message selected by the matching engine 226 the matching probability with the sender. The probability is based on a formula which uses the location 56 and time 54 differentials between this user and the sender of the selected message based on the message data provided by the message component 222.

The chat engine 230 manages chat messages and enables the communication of matched users. One embodiment of a chat engine would include the sorting of chat messages by thread, which is a specific message sequence between two users and by time within that thread.

The group component 233 manages relationships between those mobile communication device users who send matching keys 52 within a configurable time-frame 54 indicated by the validity time frame. The notification component 235 listens to internal events and sends notification messages to mobile communication device users. The notification component 235 manages relationships based on a set of rules based on location and time message was received.

The message generator 211 uses templates 232 and the output of the other components to generate messages. In one embodiment, templates are text strings which may or may not contain placeholders for user information such as name, MSISDN, time original message received, etc. For example, “Welcome first time Spooter” or “Hello <% MSISDN %>”, where the message generator would retrieve the MSISDN field associated with the incoming message and insert it in the latter template string.

The outbound message sender 210 sends the generated messages from the message generator 211 out to the mobile communication devices 200 including generating the message text and invoking an external service for sending a SMS to a mobile subscriber associated with the specific MSISDN.

In one embodiment, each mobile communication device 200 receives one welcome message from the outbound message sender 210 on a first-time interaction with the server. Additionally the mobile communication device 200 receives, after any interaction, a notification message containing information about the number of relationships. In another embodiment, the server is configured to send periodic informational messages regarding user's activities, changes in the profile, changes in the user list, etc. In yet another embodiment, a user is enabled to customize how often and what kind of messages are received.

In one embodiment, the request receiver 212 receives messages from the mobile communication devices 200 and transfers the messages for further processing by various processing engines including the matching engine 226, chat engine 230, scoring engine 228.

The request parser 213 parses the received messages from the request receiver 212 into its message components. A Request Receiver 212 receives HTTP inquiries from the Web or mobile Web. An Inbound Message Receiver 206 receives SMS message. Both store into the same data structure. The logic of the allocation and the manipulation are different. The request analyzer 214 analyzes the incoming message by extracting the request components.

The response generator 216 uses templates 232 to generate a response. The message is delivered as a web page, where the message is personalized for each user. The response sender 210 sends the messages generated by the response generator 215 to the mobile communication devices 200.

### Data Structure for Establishing Communities

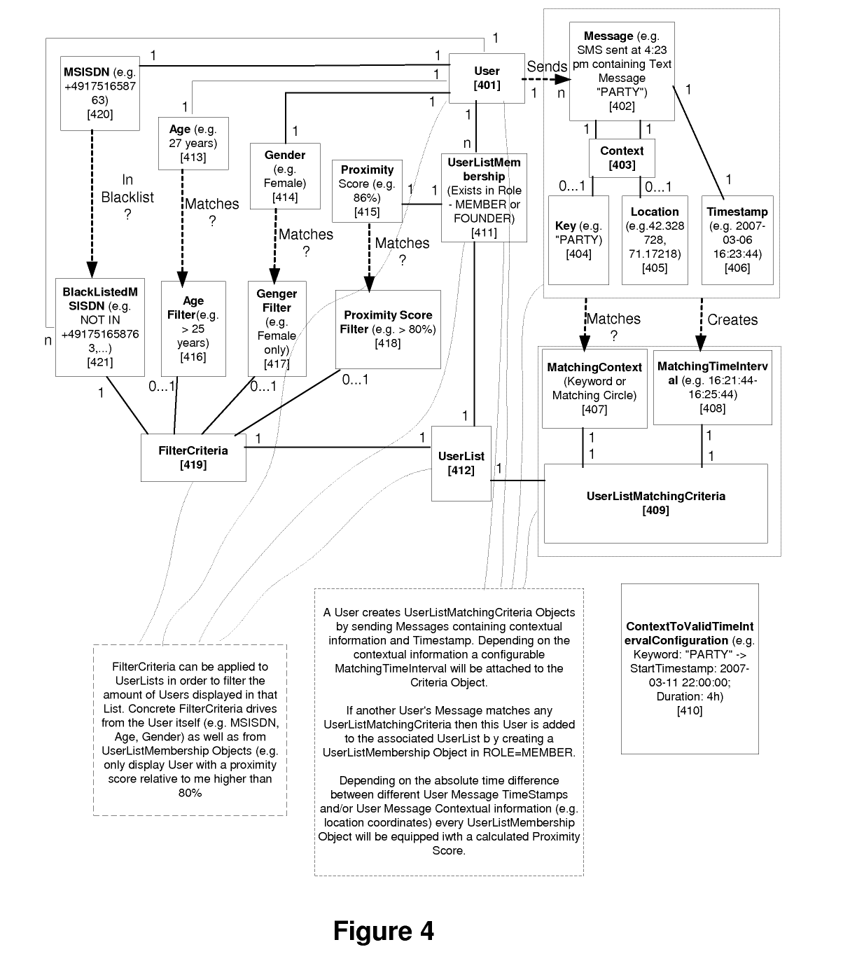

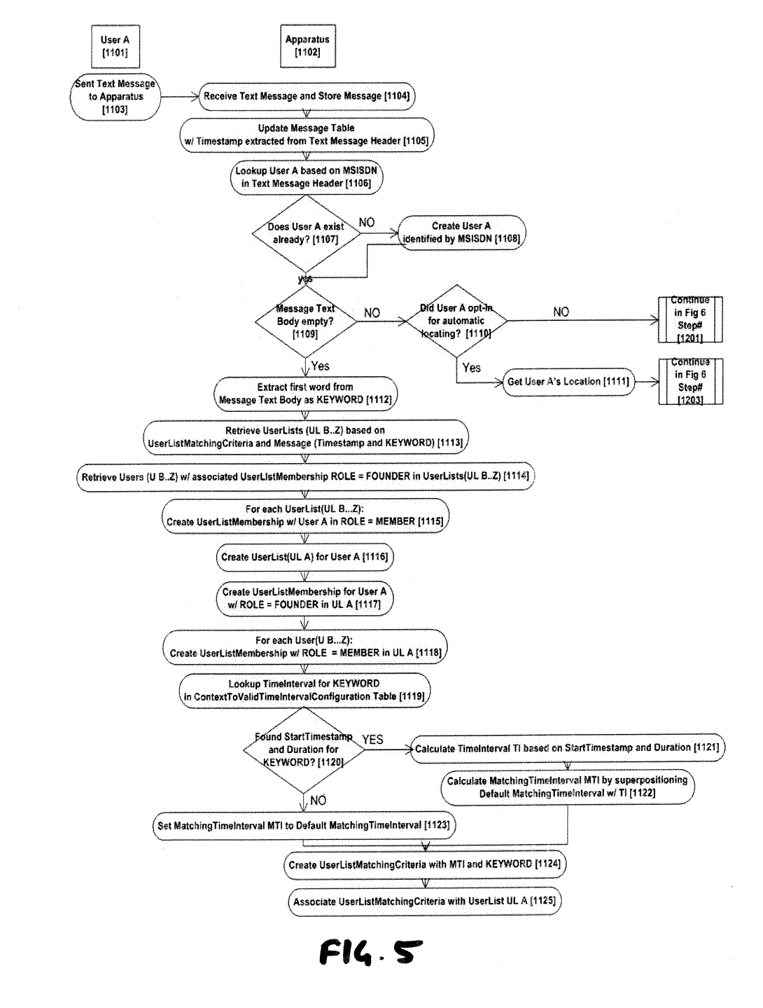

FIG. 4 illustrates one embodiment of the user data structure 401 and message data structure 402 used by the grouping component 233 (see FIG. 3). A user is identified by an MSISDN 420. Note that if one user has two MSISDN each of the MSISDNs identifies the same user. Another embodiment would include functionality to migrate a user from one MSISDN to another or to merge many MSISDNs to one user account.

User characteristics are stored with the user include age 413, gender 414. A user is a member of one or more user lists shown by a membership list 411, in a role of either member or founder. The founder can control the membership of others, where the member can only control his or her membership. Further, removing a user who is a founder would essentially delete the list and remove all other members from it. All users who are a member of a user list are identified with a member entry in the user list 412. Note that each user is the founder of one user list and member in none, one or many user lists of other users. In one embodiment, if a user deletes her user list of which he is a founder, the user is deleted from any corresponding user list of other users The filter criteria 419 are used to map the users on the user list 412 to membership on specific lists 411. The filter criteria 419 are rule driven based on one or more filters. The Blacklisted MSISDN filter 421 will block all users on the user's blacklist from having membership in any user list. The other filters are specific to the characteristics of the other user or the messages sent by that user. For instance, age criteria would map from the user's age 413 to the age filter 416, gender criteria would map from the user's gender 414 to the gender filter 417. Hence, if a user was looking for females between the ages of 25 and 30, a 27 year old woman would fit the criteria while neither a male of any age nor a 35 year old woman would. Proximity score filter 418 would match users to the user list based on the proximity score calculation of the message 402 associated with the user list 412. Each user (e.g., user 50g in FIG. 1D) may narrow down her search for a user 50e in the community 40 (see FIG. 1D) based on characteristics voluntarily and separately provided into a common data storage on the server 240 (see FIG. 3) by each user such as their photo, gender, sexual preference, and age. As a result, user and message-specific verification lists are accessible within a user interface (e.g., web user interface) and enable mobile communication device users (e.g., user 50e and 50g in FIG. 1D) to initiate communication with others and subsequently, if mutually desired, continue communication and establish a relationship with each other.

In another embodiment, the filter could interact with a message store, analyze such a message store to determine characteristics of messages sent by each use such as frequency of messages sent or number of messages sent in a given period of time, such that a filter could also reflect SMS characteristics of the user such as the number of messages sent per week.

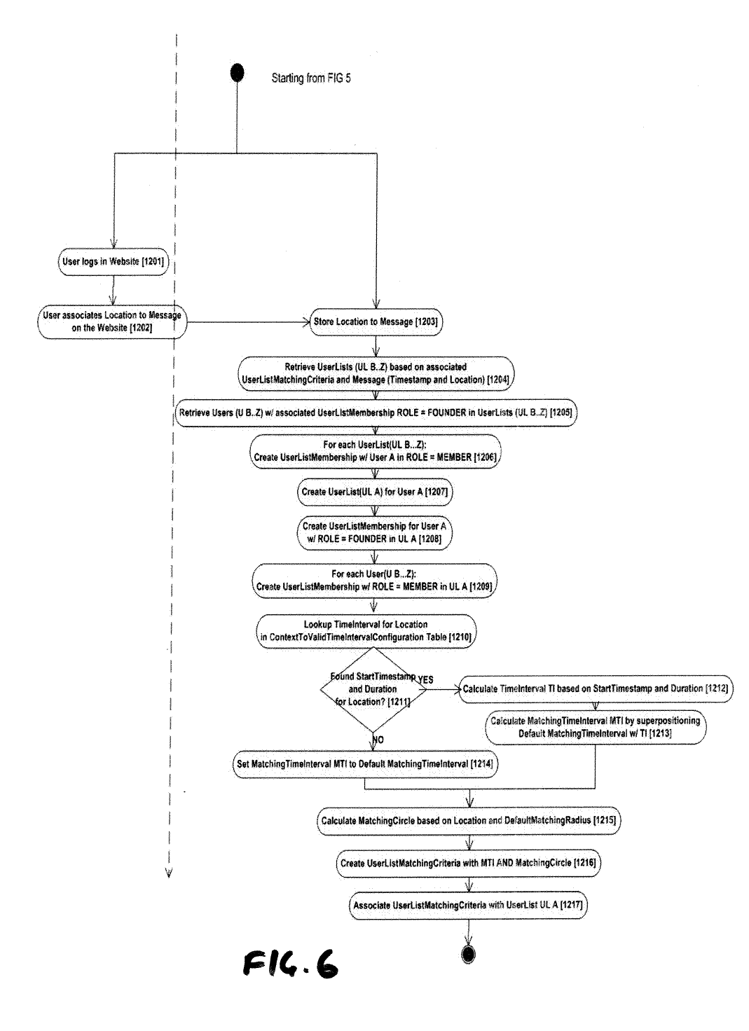

Still referring to FIG. 4, a user 401 sends one or more messages 402. The message has a context 403 which consists of a timestamp 406 and may contain either a key 404, location 405, or both. A key is a user-defined word or phrase which can identify groups of users. The key may be something that all users agree on to identify them, or some common word or phrase that all users would send to find other users such as “SPOOT” or “PARTY”. The location 405 can be part of the message, may be entered by the user on login, or may be provided by the system (see FIG. 6). A message is used to enable a user to join a user list if that message matches user list criteria 409. The criteria are based on a key match if a key is present, and a matching time interval within a predefined interval based on a pre-defined rule. In one embodiment, there would be a match if the key is syntactically, semantically, or phonetically similar to another key sent by another user.

### Process and Data Flow of Community Building

FIG. 5 illustrates a process flow from the reception of a (SMS) message until the storage of the respective data relevant for the user-defined key, for one embodiment of the present invention. User A sends a text message and the system receives and stores the message 1104. In another embodiment, binary-coded messages may be used. The request receiver 212 processes the received text message by converting the received SMS signal to a system-compatible digital signal and sends the Message 402 to the message parser 207. The message parser 205 extracts the timestamp 406 of the reception time from the context 403 of the text message 1105.

The message parser 207 extracts the MSISDN from the message header and looks up User A 1106. Note that the MSISDN is part of the SMS message header and is presumed to be in the message. In one embodiment the MSISDN is the phone number of User A. The request parser 213 passes the message components to the request analyzer 214, which determines whether User A (with the MSISDN specified) already exists, or not 1107. If the user does not exist, the request analyzer 214 passes the request to the user component 220 to create a new User A identified by the MSISDN 1108. The request analyzer determines the context of the User A's message by analysing the message body 1109: if the body is “empty” (i.e. no KEY defined), then the context will be the location of User A when sending the message. Otherwise, if the message body is not empty because a key has been defined, then the context will be defined by the key 1112. If the context has a location, the user component 220 checks if the User A has opt-in (i.e. accepted) for automatic positioning 1110. If not so, User A has to login to the website 1201 (i.e. the Internet interface to the server 240) and specify the respective location (see FIG. 6). If so, then the apparatus obtains User A's location by calling a Web service, and stores the respective location 1111. If the context includes a user-defined key, then the request analyzer 214 extracts the key from the message body and stores it as the key 1112. In one embodiment, the first word of the message body would be the key. The matching engine 226 is sent the message components and retrieves all user lists if any 1113, where the time stamp of User A's message falls within the time interval as defined in the MatchingTimeInterval 408 and the user-defined key 404 of User A's message “matches” that of the respective user list 1114. Additionally, the matching engine 226 would exclude user lists 412 “owned” by User A himself, i.e. where User A has a user list membership 411 with a role of founder in such a user list 1114. Matching engine 226 adds User A as a member of each User List by creating an entry with a role of member in User List Membership 411 for each retrieved User List 1115, Note that User A is now visible to the “founding User X” of each retrieved User List 412. The matching engine 226 passes each match to the group component 233, which then creates for User A a user list 1116. Additionally, the matching engine 226 passes the match to the scoring engine 228 creates a “(proximity) score” 415 and assigns it to the User List Membership 411. Note that the “score” is based on the temporal distance between the respective time stamps and the “similarity” between the respective user-defined keys. In one embodiment the similarity results from the semantically or phonetically algorithm.

The User Component 220 then creates the User List Membership 411 for User A with a role of founder in the new User List 1117. The User Component 220 then creates for each User B . . . Z one User List Membership 411 with a role of member in the new User List 1118. Note that Users B . . . Z are now visible to the “founding” User A. The Matching Engine 226 then determines the User List Matching Criteria 409 for User List A by looking up the Time Interval Configuration 1119 (i.e. StartTimestamp, Duration) for the user-defined key 404 in the Context 403. Additionally, the scoring engine 228 creates a proximity score 415 and assigns it to the User List Membership 1120. The matching engine 226 then determines if it found a Time Interval (StartTimestamp, Duration) for the user-defined key 1120. If a Time Interval is found, then the matching engine 228 calculates a time interval (TI) based on Start Timestamp and Duration 1121. The matching engine 226 then looks up a configurable default Matching Time Interval (DMTI) and calculates Matching Time Interval (MTI) as superposition of DMTI and TI 1122. Otherwise, if Time Interval is not found, it looks up a configurable DMTI and sets the MTI to DMTI 1123. The matching engine 226 creates a User List Matching Criteria (ULMC) 409 with MTI as Matching Time Interval 408 and the respective user-defined key as MatchingTimeContext 407 1124. The matching engine 226 associates the ULMC with the created User List A 1125. Note that now the matching engine 226 is able to compare the next incoming message with the User List Matching Criteria of User A's User List A.

FIG. 6 illustrates a data flow during registration and login between the mobile communication device 200 and the server 240 as well as from the point the location is determined in an embodiment where automatic location is enabled. In one embodiment, the client could be a web browser rather than a mobile communication device 200. There are two ways to obtain location attribute. In one embodiment the location is provided by the mobile device 200 with the message. In another embodiment, the location is entered by the user using an Internet interface.

If the location was not submitted automatically, the mobile communication device user submits user login request 1201. The server 240 receives the request 402 and parses the request 403. One embodiment of this parsing activity would be to receive a standard HTTP message with username as the MSISDN identifier and a password. The user then selects the message from a list of one or more pending messages to be processed, and provides the location the message was sent from 1203. One embodiment of this would be by enabling the user to interact with a map via the map engine 224. The location is then stored with the message 1203.

The matching engine 226 is sent the message components and retrieves all user lists if any, where the time stamp of User A's message falls within the time interval as defined in the MatchingTimeInterval 408 and the user-defined 404 of User A's message “matches” that of the respective user list 1204. Additionally, the matching engine 226 would exclude user lists 412 “owned” by User A himself, i.e. where User A has a user list membership 411 with a role of founder in such a user list 1205. The matching engine 226 adds User A as a member of each User List by creating an entry with a role of member in User List Membership 411 for each retrieved User List 1206. Note that User A is now visible to the “founding User X” of each retrieved User List 412. Matching engine 226 passes each match to the group component 233, which then creates for User A a user list 1207. Additionally, the matching engine 226 passes the match to the scoring engine 228 creates a “(proximity) score” 415 and assigns it to the User List Membership 411. Note that the “score” is based on the temporal distance between the respective time stamps and the “similarity” between the respective user-defined keys. In one embodiment the similarity results from the semantically or phonetically algorithm. The User Component 220 then creates the User List Membership 411 for User A with a role of founder in the new User List 1208. The User Component 220 then creates for each User to be added to a user list, one User List Membership 411 with a role of member in the new User List 1209. Note that each user within the user list is now visible to the “founding” User A.

The Matching Engine 226 then determines the User List Matching Criteria 409 for User List A by looking up the Time Interval Configuration (StartTimestamp, Duration) for the specific user-defined key 404 in the Context 1210. Additionally 1211, the scoring engine 228 creates a proximity score 415 and assigns it to the User List Membership 411. The matching engine 226 then determines if it found a Time Interval (StartTimestamp, Duration) for the user-defined key. If a Time Interval is found, then the matching engine 226 calculates a time interval (TI) based on Start Timestamp and Duration 1212. The matching engine 226 then looks up a configurable Default Matching Time Interval (DMTI) and calculates Matching Time Interval (MTI) as superposition of the Default Matching Time Interval (DMTI) and TI 1213. Otherwise, if a Time Interval is not found, it looks up a configurable DMTI and sets Matching Time Interval (MTI) to DMTI 1214. The matching engine 226 creates a User List Matching Criteria (ULMC) 409 with MTI as Matching Time Interval 408 and the respective user-defined key as MatchingTimeContext 1215. The matching engine 226 associates the ULMC with the created User List 1216. Note that now the matching engine 226 is able to compare the next incoming message with the User List Matching Criteria of User A's User List 1217.

### Calculating a Probability of Match to Build Communities

In one embodiment, the process of building community of two or more mobile communication device users includes calculating a matching probability between two or more mobile communication device users. When two mobile communication device users wish to establish a community, they send messages indicating their wishes to the server 240. The matching probability is calculated by determining source-location 56 and receive-time 54 for at least one message sent by one of the mobile communication device users, and by determining the source-location 56 and receive-time 54 for at least one message of at least a second mobile communication device user.

In one embodiment, the mobile communication device user enters a message and submits to the server 240. The server 240 receives a message and parses the message, which consists of the user id (MSISDN), a timestamp, and text. In one embodiment, the matching engine 226 is invoked upon receipt of the parsed message. The matching engine 226 identifies message details of the message including the context which consists of the receive timestamp, the source-location and the message components. The message components include sexual orientation, color of hair, or, any other distinguishing characteristics of the other mobile communication device user.

The matching engine 226 identifies filter criteria including the sender's sex that has to match the encountered individual's “sexual preference” as indicated in reference to a specific encounter. This holds symmetrically for both mobile communication device users and means that each mobile communication device user wants to “see and be seen by” only those individuals who match their sexual preference. Other filter criteria include the maximum temporal and the maximum geographic distance, and also each mobile communication device user's blacklist filter. The blacklist filter is a part of the user component 220. The blacklists hold symmetrically for both mobile communication device users. A mobile communication device user listed in the blacklist of another mobile communication device user can't communicate with this other mobile communication device user. The matching engine 226 identifies messages of other mobile communication device users that fit the identified filter criteria. The filter compares the user characteristics in two messages and computes the temporal and the geographical distances between the mobile communication device user's message and other mobile communication device users' messages.

Once messages have been identified as meeting the filter criteria, the encounter probability for the mobile communication device user and the other identified mobile communication device users based on a matching probability equation P(t,r) is computed. In one embodiment, the scoring engine 228 calculates the rank of each identified message. The scoring engine 228 also identifies the user profile of each identified message. A message, including a list of other mobile communication device users by their ranks by the score calculated by their matching probability, is sent to the mobile communication device. The mobile communication device receives and displays the message. The mobile communication device user then may proceed to start a chat conversation with one or more mobile communication device users in the ranked list.

In one embodiment, the list of users ranked by the score is used as the user response and received by the user in a web user interface. In another embodiment, the list of users ranked by the score is used as e-mail content and received by the user in their e-mail client. In another embodiment, the list of users ranked by the score is delivered as a message or by request to a 3^{rd} party.

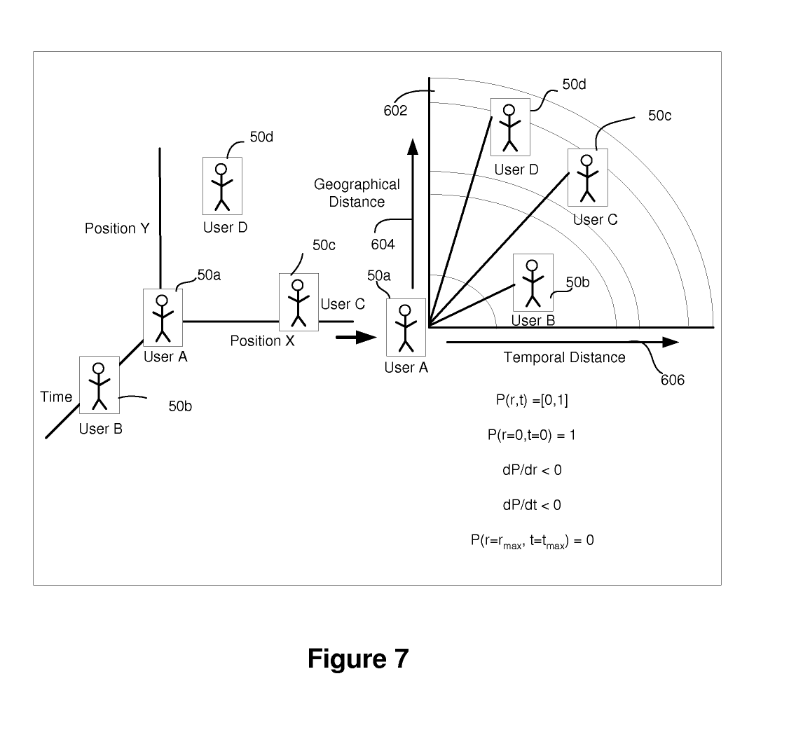

FIG. 7 illustrates one embodiment of a matching probability equation P(t,r). The mobile communications device 200 initiating the communication is associated with the event at timestamp t=0 and position r=0, where r is the distance between the user A 50a who is attempting to initiate the community and other users 50b, 50c, 50d in the proximity and t 606 represents the time difference between when the message by the user 50a initiating the contact was received and when the other users 50b, 50c, 50d claimed to have been in the vicinity. A maximum value is defined for distance rₘₐₓ and difference in time between the time associated with the initiating event and time of a user's presence in the location, tₘₐₓ. A function is defined along a probability curve, where the value associated with a user at the same location and time as the initiator, P(0,0) is 1, and the value associated with a user at the outer limits of time and distance, P(tₘₐₓ, rₘₐₓ), is 0. It is also presumed that the function is linear and continuous, such that the partial derivatives of the function with respect to r or t is always negative; the max value is at P(0,0), the min value is at P(tₘₐₓ, rₘₐₓ), and the function is smooth in between. The probability score can then be multiplied by some value in one embodiment, or weighted such that high probabilities get very high scores and low probabilities get very low scores. The resulting scores can then be presented to the user as a multi-digit integer value, for instance between 01 and 99 where 01 is the lowest and 99 is the highest.

One embodiment of the matching probability equation P(t,r) is:

$$\frac{1}{{e}^{a * r + b * t}}$$

r=radius [meter] {geographical distance between two message locations}

t=time [second] {temporal distance between two message receive times}

e=“natural” exponential (about 2.71828)

a,b=constants

In one embodiment a=0.005 and b=0.0025

Another embodiment of the matching probability equation P(t,r) is:

$$\frac{{( a + c )}^{e} - {\{ {a ( r / {r}_{max} )}^{b} + {c ( t / {t}_{max} )}^{d} \}}^{e}}{{( a + c )}^{e}}$$

r=radius [meter] {geographical distance between two message locations}

t=time [second] {temporal distance between two message receive times}

rₘₐₓ=filter criteria for max geographical distance of two message locations [meter]

tₘₐₓ=filter criteria for max temporal distance of two message locations [second]

a,b,c,d,e=constants

a+c>0

Exemplary values—a=1,800 and b=6 and c=1,000 and d=3 and e=0.2

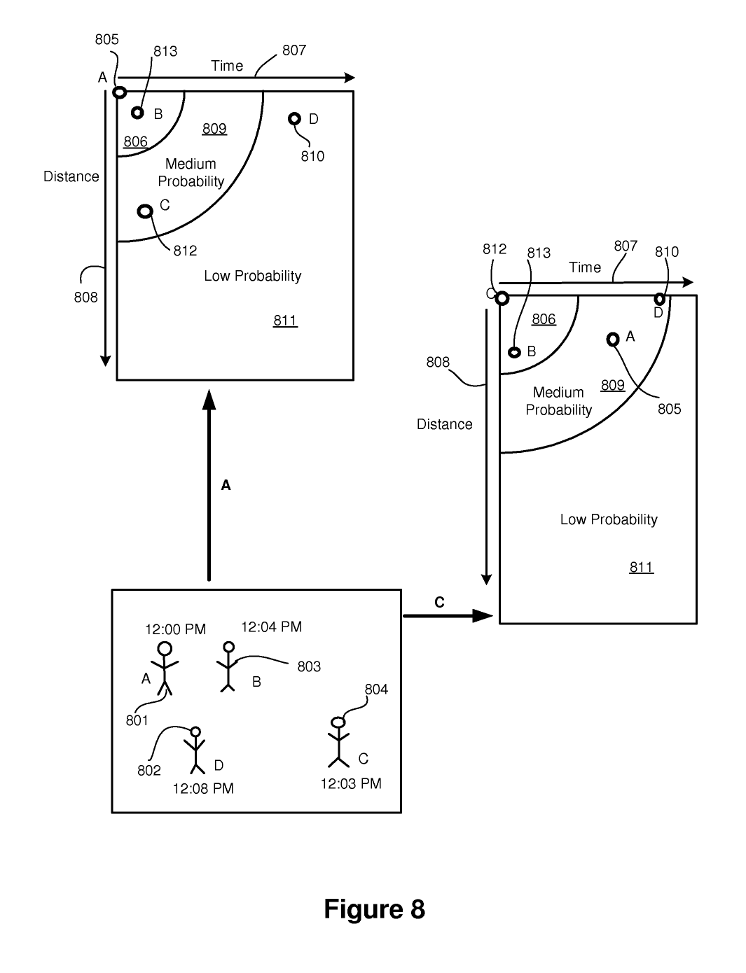

FIG. 8 shows two views of the same interaction between two users. One showing the scores from A's viewpoint 801, the other showing the scores from C's viewpoint 804. From A's scoring, A is at his own t=0, r=0 (805). B is located in distance and time 813 at a combination which is arbitrarily set to a high probability region 806. In one embodiment, this means it is more likely than not that the person intended to make contact. C is located in a region where the scoring indicates a lower score due to a farther distance from A compared to B 812. This places C in region which is arbitrarily defined as a medium probability region. In one embodiment this means that the system is unable to determine whether or not C intended to make contact with A. D 810 is the same distance that B was from A, but responded at a much later time. The scoring algorithm has placed D with a low score, hence a low probability region. C's view produces analogous but different results. In C's view C is at his own t=0, r=0 location 812, meaning the probability he intended to make contact with himself is 1. B is close to C and sent the message close in time to C's 813, so B is in a high score region relative to C 806. A 805 and D 810 are both in a medium score region relative 809.

### Web User Interface

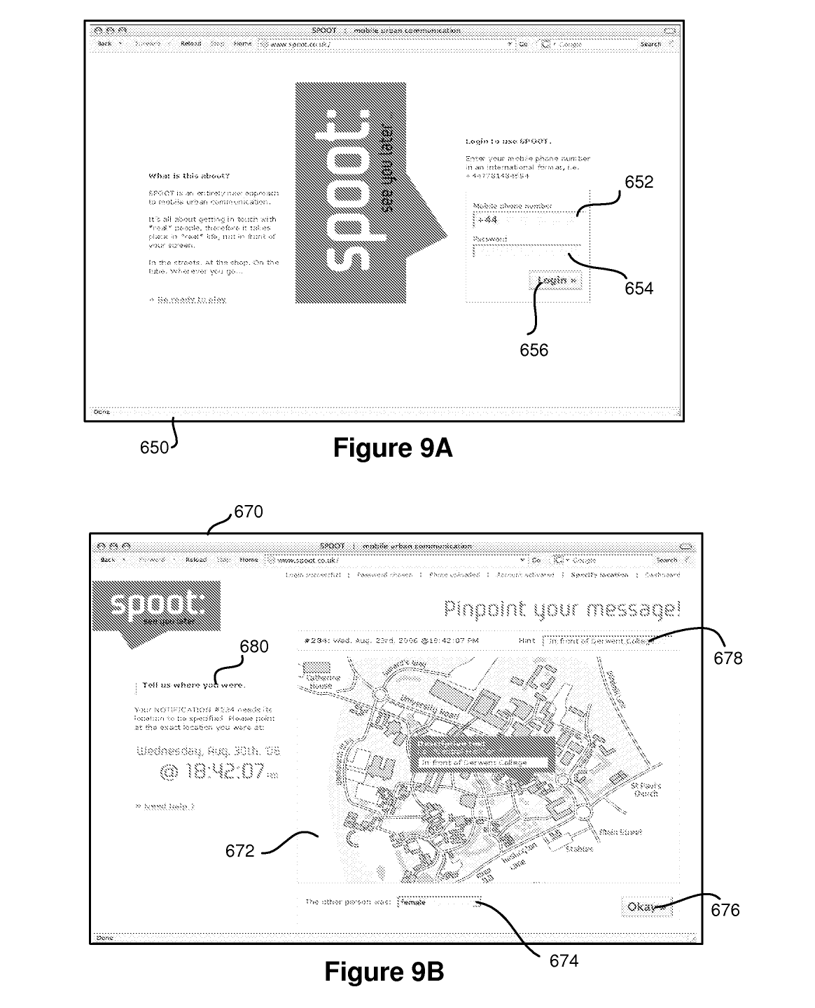

FIG. 9A shows a sample web interface login screen 650. In one embodiment, a user would enter his phone number 652 along with a password 654, and then press the login button 656 to initiate a session. In another embodiment, the login screen 650 would have a user entering a user defined identification string which the user previously associated with his or her user account along with a valid phone number. In yet another embodiment, the digital certificate may be used for login.

FIG. 9B illustrates, in one embodiment, a session where a user acted as an initiator to send a message and is looking for another individual who they met at a location 405 where they sent the message 670. The system prompts the user to tell it where he was, given the date and time of the message 680. The system has an approximate position shown on a map 672 and a hint that the user sent with the message to help pinpoint the position 678. The user then selects the location 405 on the map which approximates where they were to greater accuracy, and selects one or more characteristics from a set of lists 674 presented to the user, which in this embodiment shows gender.

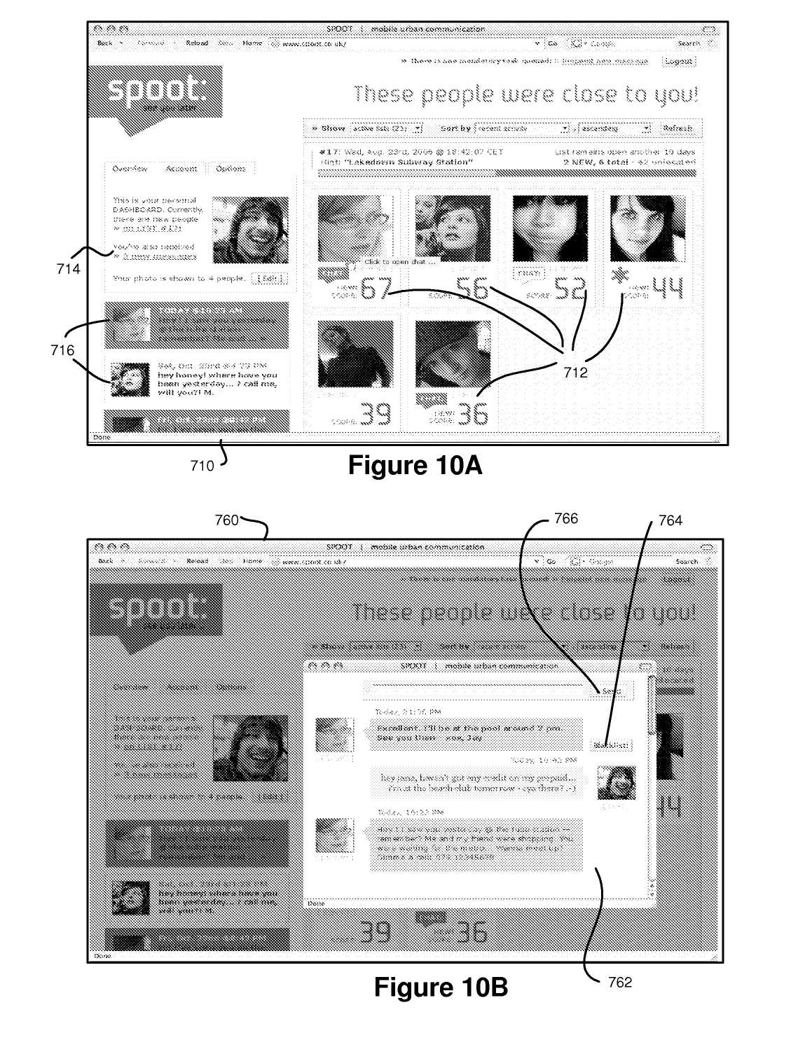

FIG. 10A shows an embodiment of a user list screen 710 which shows the list of users ranked by the score. Once the user selects location 405, time 406, and general characteristics 670 of the person the user is looking for, the user is presented with a representation of the list 712 of users ranked by the score. In one embodiment, a picture of the person, the rank score, and, if they wish to communicate with you, a “chat with me” symbol is shown. The user also sees his/her own picture along with any alerts such as how many people have looked at you in this group, and how many messages from these people you have pending 714, along with a list of recent threads of messages 716.

FIG. 10B shows an embodiment of what a specific thread display would look like 760. A user selects a thread from the group of threads 716, and then sees the detailed conversation 762. A user may then respond and send a new message to the person 766, or blacklist the person and block any further communication 764.

The embodiments of the present invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While this invention has been described in terms of several preferable embodiments, it will be appreciated that those skilled in the art upon reading the specifications and studying the drawings will realize various alternations, additions, permutations and equivalents thereof. It is therefore intended that the present invention includes all such alterations, additions, permutations, and equivalents as fall within the true spirit and scope of the invention, permutations, and equivalents as fall within the true spirit and scope of the invention.

What is claimed is:

1. A computer implemented method of establishing a community including a first mobile communication device user and a second mobile communication device user, the computer implemented method comprising:
receiving a first message from the first mobile communication device user wherein the first message is sent from a mobile communication device in possession of the first mobile communication device user;
receiving a second message from the second mobile communication device user wherein the second message is sent from a mobile communication device in possession of the second mobile communication device user;
parsing the first message to determine a first user identifier and a first user-defined key;
parsing the second message to determine a second user identifier and a second user-defined key;
calculating a matching probability between the first mobile communication device user and the second mobile communication device user based on at least of one of:
a proximity of distance between the first mobile communication device user and the second mobile communication device user, defined to be a straight-line distance between location of the first mobile communication device when the first message was sent and location of the second mobile communication device when the second message was sent;
a proximity of time between the first mobile communication device user and the second mobile communication device user, defined to be a time difference between the receiving of the first message and the receiving of the second message; and
a matching of the first user-defined key and the second user-defined key, wherein the matching is based on at least one of exact word matching, syntactic matching, phonetic matching, and semantic matching.

2. The computer implemented method of establishing the community as recited in claim 1, where the calculating the matching probability further comprising:
defining an upper bound for the proximity of distance; and
defining an upper bound for the proximity of time,
wherein the matching probability is 0 when the proximity of distance is greater than or equal to the upper bound for the proximity of distance and the proximity of time is greater than or equal to the upper bound for the proximity of time, and the matching probability when the first communication device user and second communication device user are collocated at the time the messages were sent is 1, the matching probability varies linearly for changes in the proximity of distance through the upper bound for distance, the proximity of time varies linearly for changes in the proximity in time through the upper bound for time.

3. The computer implemented method of establishing the community as recited in claim 2, further comprising:
assigning the second user identifier to a user list associated with the first mobile communication device user, wherein the assigning is done when the probability of a match is greater than an acceptable value of the probability of a match; and
enabling first communication device user to send, receive, and manage SMS messages between the first communication device user and any user in the list.

4. The computer implemented method of establishing the community as recited in claim 3, wherein the acceptable value of the matching probability is defined by the first mobile communication device user.

5. The computer implemented method of establishing the community as recited in claim 3, wherein the location of the first mobile communication device is provided by a service provider network of the first mobile communication device and the location of the second mobile communication device is provided by a service provider network of the second mobile communication device.

6. The computer implemented method of establishing the community as recited in claim 3, wherein the location of the first mobile communication device is provided by the first mobile communication device user and the location of the second mobile device is provided by the second mobile communication device user.

7. The computer implemented method of establishing the community as recited in claim 6, wherein the location of the first mobile communication device is entered by the first mobile communication device user via an interactive map-based facility provided by an Internet website.

8. The computer implemented method of establishing the community as recited in claim 3, wherein the first mobile communication device user may exclude one or more mobile communication device users from the user list associated with the first mobile communication device user.

9. The computer implemented method of establishing the community as recited in claim 3, wherein the first mobile communication device user defines a criteria for enabling adding of mobile communication device users based on at least one of gender, sexual preference, and age range.

10. The computer implemented method as recited in claim 3, wherein the second user identifier is a MSISDN identifier associated with the second mobile communication device.

11. An apparatus for establishing a community of mobile communication device users comprising:
an inbound message receiver to receive a request message sent from a mobile communication device;
an outbound message sender to convert a response message according to a mobile communication protocol and to send the response message to the communication device; and
a scoring engine to calculate a probability of a match between at least two mobile communication device users, wherein the probability of the match is calculated using at least one of a distance between the mobile communication devices users, a difference in time of receipt of messages from the mobile communication device users, and, a match of user-defined keys.

12. The apparatus for establishing the community as recited in claim 11, further comprises a map engine to enable interactive selection of a location through a location map to be associated with the request message.

13. The apparatus for establishing the community as recited in claim 12, further comprises a message component to analyze the request message to determine if a mobile communication device user that sent the request message meets a criteria to be added a user list of another mobile communication device user.

14. The apparatus for establishing the community as recited in claim 13, further comprises a group component to manage user lists of the mobile communication device users.

15. The apparatus for establishing the community as recited in claim 14, further comprises a template component to manage templates of messages to help the mobile communication device users in generating of messages.

16. The apparatus for establishing the community as recited in claim 15, further comprises a user component to manage mobile communication device user specific matching criteria.

17. The apparatus in claim 11, wherein the inbound message receiver receives the request message via SMS protocol.

18. The apparatus in claim 11, wherein the inbound message receiver receives the request message via HTTP protocol.

19. A computer readable media having program instructions executing a method for establishing a community including a first mobile communication device user and a second mobile communication device user, the computer readable media comprising:
program instructions for receiving a first message from the first mobile communication device user wherein the first message is sent from a mobile communication device in possession of the first mobile communication device user;
program instructions for receiving a second message from the second mobile communication device user wherein the second message is sent from a mobile communication device in possession of the second mobile communication device user;
program instructions for parsing the first message to determine a first user identifier and a first user-defined key;
program instructions for parsing the second message to determine a second user identifier and a second user-defined key;
program instructions for calculating a matching probability between the first mobile communication device user and the second mobile communication device user based on at least of one of:
a proximity of distance between the first mobile communication device user and the second mobile communication device user, defined to be a straight-line distance between location of the first mobile communication device when the first message was sent and location of the second mobile communication device when the second message was sent;
a proximity of time between the first mobile communication device user and the second mobile communication device user, defined to be a time difference between the receiving of the first message and the receiving of the second message; and
a matching of the first user-defined key and the second user-defined key, wherein the matching is based on at least one of exact word matching, syntactic matching, phonetic matching, and semantic matching.

20. The computer readable media as recited in claim 19, where the calculating the matching probability further comprising:
program instructions for defining an upper bound for the proximity of distance; and
program instructions for defining an upper bound for the proximity of time,
wherein the matching probability is 0 when the proximity of distance is greater than or equal to the upper bound for the proximity of distance and the proximity of time is greater than or equal to the upper bound for the proximity of time, the matching probability is 1 when first communication device user and second communication device user are collocated at the time the messages were sent, the matching probability varies linearly through the upper bound for distance, the proximity of time varies linearly for changes in the proximity in time through the upper bound for time.

21. The computer readable media as recited in claim 19, where the calculating the matching probability further comprising program instructions for calculating a value of e^{-(a*r+b*t)}
where r=proximity in distance between the two messages in meters,
t=proximity in time between the two messages in seconds,
e=natural exponential constant, and
a and b are constants.

22. The computer readable media as recited in claim 21, where the calculating the matching probability further comprising program instructions for calculating a value of ((a+c)^{e}−{a(r/rₘₐₓ)b+c(t/tₘₐₓ)^{d}}^{e})/(a+c)^{e}
where r=proximity in distance between the two messages in meters,
t=proximity in time between the two messages in seconds
rₘₐₓ=filter criteria for max proximity in distance of two message locations in meters
tₘₐₓ=filter criteria for max proximity in time of two messages in seconds
a, b, c, d, and e are constants,
and a+c>0.

23. The computer readable media as recited in claim 22, further comprises program instructions for assigning the second user identifier to a user list associated with the first mobile communication device user, wherein the assigning is done when the probability of a match is greater than an acceptable value of the matching probability, the acceptable value being definable by the first mobile communication device user.

24. In a server that is connected to a worldwide communication network, a method of identity verification comprising:
receiving from a first user's mobile communication device a first message including a identification characteristic, wherein the identification characteristic is defined by the first user;
recording a time of receipt of the first message;
receiving a plurality of messages, one from each of a plurality of users' mobile communication devices at a time later than receipt of the first message, each of the plurality of messages including a user-defined key;
recording a time of receipt of each of the plurality of messages;
matching the user-defined key in each of the plurality of messages received within a defined time delay from the time of receipt of the first message with the identification characteristic, wherein the matching includes comparing the user-defined key with the identification characteristic; and
selecting each of the plurality of users for whom the matching results in a match.

25. The method of identity verification as recited in claim 24, wherein the first message further includes a first location of the first user at the time of receipt of the first message.

26. The method of identity verification as recited in claim 25, wherein each of the plurality of messages further includes a location.

27. The method of identity verification as recited in claim 26, wherein the selecting further comprises determining that the location is within a defined geographical area around the first location.

28. The method of identity verification as recited in claim 27, wherein the first message further includes a first user-defined key.

29. The method of identity verification as recited in claim 28, wherein each of the plurality of messages further includes a user-defined key.

30. The method of identity verification as recited in claim 29, wherein the selecting further comprising comparing the user-defined first key with the user-defined key.
